(19) United States
(12) Patent Application Publication
(10) Pub. No.: US 2011/0019100 A1
(43) Pub. Date: Jan. 27, 2011

(54) TOUCH-SENSITIVE GAIN CONTROL DEVICE

(76) Inventor: SHAN-GOW LO, Tainan (TW)

Correspondence Address: LEONG C. LEI, PMB # 1008, 1839 YGNACIO VALLEY ROAD, WALNUT CREEK, CA, 94598, US

(21) Appl. No.: 12/507,815

(22) Filed: Jul. 23, 2009

(51) Int. Cl. H04N 5/44

(52) U.S. Cl. 348/725; 348/E05.115

(57) ABSTRACT

The device contains a base, a circuit board, a protective cover, a control panel, and top cover. The base accommodates the circuit board having a touch-sensitive IC, a PIN diode, and other common electronic elements. The circuit board is covered by the protective cover and the control panel is positioned on top of the protective cover with a gap therebetween through which a cable connecting the control panel and the circuit board passes. The control panel has a number of copper foils functioning as electrodes. The top cover has a number of touch contacts corresponding to the copper foils. An adhesive tape is positioned between the touch contacts and the cooper foils so that the former is not in direct with the latter.

### TECHNICAL FIELD OF THE INVENTION

The present invention generally relates to a gain control device for TV signal, and especially relates to a touch-sensitive gain control device which, by the contact of fingers, could adjust the strength of the TV signal passing through the gain control device.

### DESCRIPTION OF THE PRIOR ART

A conventional gain control device for TV signal, regardless of its shape design, usually adopts dials or buttons as user interface. These dials or buttons of course provide appropriate adjustment function. However, there are a number of disadvantages.

First, dials or buttons involve mechanical contacts which will age and deteriorate. After a period of time, the dials or buttons would not work reliably. The gain control device is therefore less practical as it has a higher failure rate.

Secondly, due to the higher failure rate, the gain control device has a shorter operational life and therefore is not quite economic.

In addition, dials or buttons have to be configured on a flat panel for steadiness. They are therefore less flexible and not visually appealing.

### SUMMARY OF THE INVENTION

The present invention provides a touch-sensitive gain control device for TV signal, through which the signal strength could be adjusted by finger's contacts. The gain control device contains a base, a circuit board, a protective cover, a control panel, and top cover. The base accommodates the circuit board whose two opposing ends have an input terminal and an output terminal, respectively. The circuit board also has a touch-sensitive IC, a PIN diode, and other common electronic elements. The circuit board is covered by the protective cover and the control panel is positioned on top of the protective cover with a gap therebetween through which a cable connecting the control panel and the circuit board passes. The control panel has a number of copper foils functioning as electrodes and LEDs as indicators. The top cover has a number of touch contacts corresponding to the copper foils. An adhesive tape is positioned between the touch contacts and the cooper foils so that the former is not in direct with the latter. When a touch contact is touched by a finger, it is sensed and a gain control circuit on the circuit board adjusts its gain so that the TV signal strength is adjusted. The LEDs are for presenting the TV signal's strength.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a touch-sensitive gain control device according to an embodiment of the present invention.

FIG. 2 is a perspective diagram showing the touch-sensitive gain control device of FIG. 1 after its assembly.

FIG. 3 is a perspective diagram showing a control panel of the touch-sensitive gain control device of FIG. 1.

FIG. 4 is a sectional diagram showing a control panel attached to a top cover of the touch-sensitive gain control device of FIG. 1.

FIG. 5 is a perspective diagram showing a touch contact of the touch-sensitive gain control device of FIG. 1 is touched by a finger.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

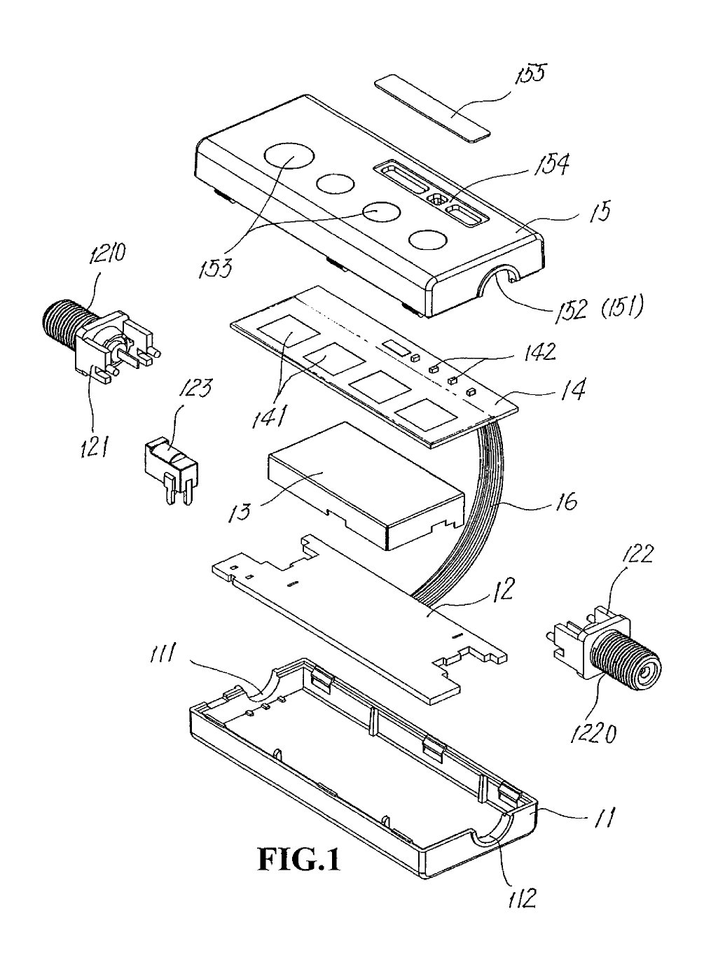

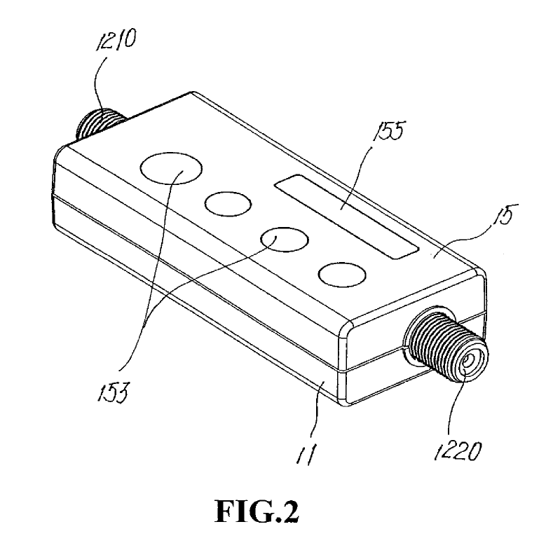

As illustrated in FIGS. 1 and 2, a touch-sensitive gain control device mainly contains a base 11, a circuit board 12, a protective cover 13, a control panel 14, and a top cover 15. The base 11 is top-open container having two curved indentations 111 and 112 along two opposing side walls' top edges, respectively. The circuit board 12 is placed inside the base 11 and has electronic elements such as a touch-sensitive IC and a PIN diode, etc. installed. These electronic elements are not drawn as they are not the subject matter of the invention and should be familiar to those skilled in the related arts. At two opposing ends of the circuit board 12, an input terminal 121 and an output terminal 122 with connectors 1210 and 1220 are configured, respectively. The input terminal is also connected to a DC (direct-current) device 123. The electronic elements on a top side of the circuit board 12 are sealed by the protective cover 13. The control panel 14 is positioned on top of the protective cover 13 and is connected to the circuit board 12 through a cable 16. On a top side of the control panel 14, there are a number of copper foils 141 functioning as sensing electrodes and a number light emitting diodes (LED) 142 as indicators. The top cover 15 is joined to the base 11 to seal the foregoing components therewithin. Corresponding to the curved indentations 111 and 112, the top cover 15 also has two curved indentations 151 and 152 along two opposing side walls' bottom edges. Corresponding to the copper foils 141, there are touch contacts 153 on a top side of the top cover 15. For the LEDs 142, the top cover 15 has a slot opening 154 for exposing the LEDs 142. The slot opening 154 is covered by a transparent plate 155.

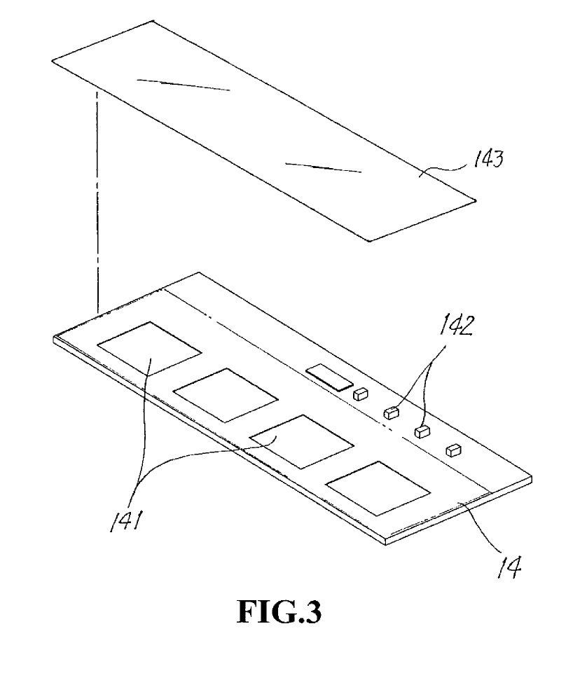

To assembly the device, the input and output terminals 121 and 122 are first connected to the circuit board 12. Depending on the application, appropriate connectors 1210 and 1220 could be adopted. The circuit board 12 along with the terminals 121 and 122 and connectors 1210 and 1220 is then placed in the base 11, with the connectors 1210 and 1220 resting in the curved indentations 111 and 112, respectively. The protective cover 13 is subsequently placed in the base 11 and joined to the circuit board 12. The control panel 14 is placed on top of the protective cover 13 with a gap therebetween, thereby allowing the cable 16 connecting the control panel 14 and the circuit board 12 to pass through. As shown in FIG. 3, the control panel 14 is attached an inner surface of the top cover 15 by an adhesive tape 143 so that the copper foils 141 are not directly contacted. The top cover 15 is finally joined to the base 11 with the connectors 1210 and 1220 sealed by the curved indentations 151 and 152, respectively.

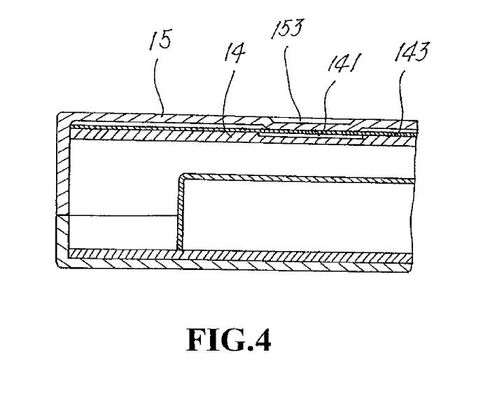

As illustrated in FIGS. 3 and 4, a number of copper foils 141 functioning as electrodes are arranged on a top surface of the control panel 14. Along a side of the copper foils 141, a number of LEDs 142 are configured. If the copper foils 141 are directly contacted, the signal strength would be too strong for the device to operate normally. Therefore the copper foils 141 are covered by the adhesive tape 143 which also helps attaching the control panel 14 to the top cover 15's inner surface. Therefore, when the touch contacts 153 are pressed by a user's finger, the copper foils 141 are not directly touched. As the human body is a natural conductor, the touch-sensitive IC on the circuit board 12 could immediately sense that the user's finger has touched a touch contact 153.

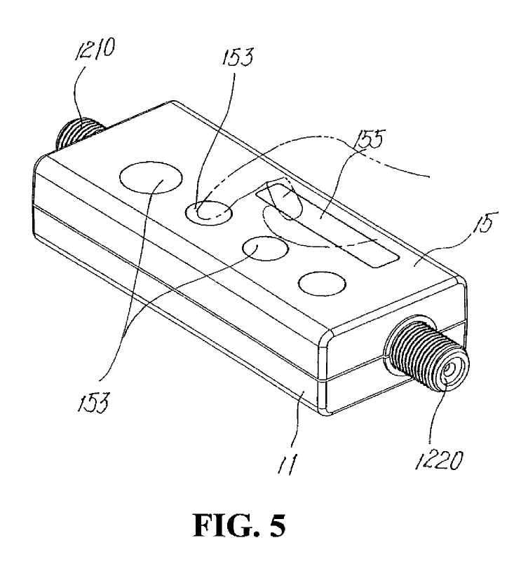

As shown in FIG. 5, when a touch contact 153 on the top cover 15 is touched by a finger, the digital output (i.e., 0 and 1) from the touch-sensitive IC is converted into a DC bias applied to a PIN diode to adjust the bias current flowing through the PIN diode. In other words, the PIN diode's impedance is varied and the high-frequency signal's gain is adjusted accordingly. In the mean time, different numbers of LEDs 142 are turned on to reflect the signal strength.

Another major feature of the present invention is that the gain control device could be directly integrated in an indoor TV antenna or other control device, or it could be directly connected to a portable computer so that, when watch broadcast TV programs, the gain control device could be used to adjust the signal strength by the touch contacts. In addition, the control panel 14 could be made of a flexible material and therefore it could be easily bended to conform to a curved surface. The present invention thereby has overcome the prior art's disadvantage that dials or buttons could not be used on a curved surface. With the present invention, a gain control device with appealing curved design and the colorful LEDs is more attractive to users.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A gain control device for a TV signal, comprising:
a base;
a circuit board housed inside said base, said circuit board providing a gain adjustment means utilizing a touch-sensitive IC and a PIN diode;
a control panel connected to said circuit board through a cable, said control panel having a plurality of copper foils on a top surface of said control panel; and
a top cover joining said base to seal said circuit board and said control panel inside, said top cover having a plurality of touch contacts corresponding to said copper foils of said control panel;
wherein said control panel is attached to an inner surface of said top cover by an adhesive tape so that said touch contacts are not in direct contact with said copper foils; and, when a touch contact is touched by a finger, said TV signal's strength is adjusted by said gain adjustment means.

2. The touch-sensitive gain control device according to claim 1, wherein a plurality of LEDs are configured on said top surface of said control panel for indicating said TV signal's strength.

3. The touch-sensitive gain control device according to claim 1, wherein said gain adjustment means is to convert a digital output of said touch-sensitive IC into a DC bias applied to said PIN diode so as to control a gain to said TV signal.

4. The touch-sensitive gain control device according to claim 1, wherein said control panel is made of a flexible material so that said control panel is capable of conforming to a curved surface.
